(19) United States
(12) Patent Application Publication
(10) Pub. No.: US 2023/0303882 A1
(43) Pub. Date: Sep. 28, 2023

(54) INK SET

(71) Applicant: RISO KAGAKU CORPORATION, Tokyo (JP)

(72) Inventors: Ryo SHINOTSUKA, Ibaraki (JP); Takumi MATSUDA, Ibaraki (JP); Yuki URANO, Ibaraki (JP); Tetsuya SHIRAISHI, Ibaraki (JP)

(21) Appl. No.: 18/184,115

(22) Filed: Mar. 15, 2023

(30) Foreign Application Priority Data
Mar. 22, 2022 (JP) 2022-045430
Mar. 10, 2023 (JP) 2023-037325

(51) Int. Cl. C09D 11/54; C09D 11/38; C09D 11/322; C09D 11/023; C09D 11/102

(52) U.S. Cl. CPC C09D 11/54; C09D 11/38; C09D 11/322; C09D 11/023; C09D 11/102

(57) ABSTRACT

Provided is an ink set including: an inkjet aqueous pretreatment liquid containing water and a polyvalent metal salt A; an aqueous inkjet ink; and a cleaning liquid containing water, a water-soluble organic solvent B with an SP value of at least 11 (cal/cm^{3)1/2}, and a monovalent metal salt C, in which the monovalent metal salt C contains a metal with a higher ionization tendency than a metal of the polyvalent metal salt A.

### CROSS REFERENCE TO RELATED APPLICATIONS

This application is based upon and claims the benefit of priority from the prior Japanese Patent Application No. 2022-045430, filed on Mar. 22, 2022, the entire contents of which are incorporated by reference herein, and the prior Japanese Patent Application No. 2023-037325, filed on Mar. 10, 2023, the entire contents of which are incorporated by reference herein.

### BACKGROUND OF THE INVENTION

### Field of the Invention

Embodiments of the present invention relate to an ink set.

### Description of the Related Art

An ink jet recording method is a printing method in which a liquid ink having high fluidity is jetted from fine nozzles and adhered to a substrate to thereby perform printing. This method enables printing of high-resolution and high-quality images to be conducted at high speed and with little noise using a relatively inexpensive device, and has therefore rapidly become widespread in recent years. In terms of inks, aqueous-type inks have become widespread since it is possible to obtain printed matter having high image quality at low cost. Aqueous inks have enhanced drying properties due to containing water, and also have an advantage of excellent environmental friendliness.

In one example of a method for when an aqueous ink is used, a substrate is treated using a pretreatment agent containing an aggregating agent and then the aqueous ink is applied.

In inkjet printing, due to inks and the like sticking at jetting ports of nozzles of an inkjet head, jetting failures such as misalignment of the jetting directions of inks from the nozzles and non-jetting may be caused. To avoid this, the inkjet head and the like are generally cleaned.

JP 2015-21084 A discloses an ink set including a treatment liquid containing an aggregating component, an ink composition, and a maintenance liquid used for removing the ink composition that has adhered to an ink jet recording head, and an image formation method using these.

### SUMMARY OF THE INVENTION

One embodiment of the present invention relates to an ink set including: an inkjet aqueous pretreatment liquid containing water and a polyvalent metal salt A; an aqueous inkjet ink; and a cleaning liquid containing water, a water-soluble organic solvent B with an SP value of at least 11 (cal/cm^{3)1/2}, and a monovalent metal salt C, in which the monovalent metal salt C contains a metal with a higher ionization tendency than a metal of the polyvalent metal salt A.

### DETAILED DESCRIPTION OF THE EMBODIMENTS

Embodiments of the present invention will be described below in detail, but needless to say, the present invention is not limited to these embodiments, and various modifications and alterations are possible.

An ink set according to one embodiment is an ink set including an inkjet aqueous pretreatment liquid (hereinafter sometimes simply referred to as a “pretreatment liquid”) containing water and a polyvalent metal salt A; an aqueous inkjet ink (hereinafter sometimes simply referred to as an “aqueous ink” or an “ink”); and a cleaning liquid containing water, a water-soluble organic solvent B with an SP value of at least 11 (cal/cm³)^{1/2}, and a monovalent metal salt C, in which the monovalent metal salt C contains a metal with a higher ionization tendency than a metal of the polyvalent metal salt A.

Stable jetting of the pretreatment liquid and ink by means of an inkjet method is advantageous in terms of stable quality and the like. Cleaning the paths and the like may be effective for suppressing a failure in jetting from an inkjet head. However, it is desirable that good cleaning effects can be obtained for both the ink and pretreatment liquid in cleaning the paths of the ink and pretreatment liquid and the inkjet head in those cases in which the pretreatment liquid and ink are jetted by means of the inkjet method.

In the cleaning of the path and the like, in order to achieve good cleaning effects, it is preferable that the cleaning liquid be able to be mixed with each of the ink and the pretreatment liquid in a favorable manner, and that the amount of foreign matter generated due to mixing of the cleaning liquid and the pretreatment liquid and the amount of foreign matter generated due to mixing of the cleaning liquid and the ink be small. In other words, it is preferable that the mixing stability be good.

Meanwhile, suppose that the pretreatment liquid contains a polyvalent metal salt such as a calcium salt and a magnesium salt as an aggregating component, for example. In this case, poorly water-soluble crystalline foreign matter such as calcium hydroxide tends to be formed by polyvalent metal salt cations. This may cause clogging of the nozzles of the inkjet head. This kind of poorly water-soluble crystalline foreign matter may not be sufficiently cleaned by using a cleaning liquid for ink that has a solvent composition similar to that of an ink, for example. In addition, poorly water-soluble crystalline foreign matter generally tends to be easily dissolved in acid components, for example. However, if acid components are added to the cleaning liquid, components such as the colorant of the ink may aggregate. This may not be suitable for cleaning the ink.

When an ink set of one embodiment is used, excellent cleaning effects may be possible for both the pretreatment liquid and the aqueous ink in cleaning. The reasons for this are surmised to be as follows but the reasons are not limited thereto.

The pretreatment liquid contains a polyvalent metal salt A. Since polyvalent metal salts generally tend to have a high polarity, the pretreatment liquid is less likely to disperse or dissolve in a water-soluble organic solvent having a low polarity. However, in those cases in which the cleaning liquid contains a water-soluble organic solvent B of which the SP value is at least 11 (cal/cm^{3)1/2} and the polarity is relatively high, the polyvalent metal salt A of the pretreatment liquid may be relatively easily dispersed or dissolved in the cleaning liquid. In addition, the water-soluble organic solvent B with an SP value of at least 11 (cal/cm^{3)1/2} may also act well on dispersible components such as a colorant or resin particles contained in the ink. In addition, in those cases in which the monovalent metal salt C of the cleaning liquid contains a metal with a higher ionization tendency than the metal of the polyvalent metal salt A of the pretreatment liquid, a monovalent metal salt that is relatively soluble in water due to the metal of the monovalent metal salt C is formed in place of poorly water-soluble crystals derived from the polyvalent metal of the polyvalent metal salt A, and accordingly the amount of poorly water-soluble foreign matter may be reduced.

### Inkjet Aqueous Pretreatment Liquid

The ink set of one embodiment can contain a pretreatment liquid.

The pretreatment liquid can contain water and the polyvalent metal salt A.

The polyvalent metal salt A can contain a divalent or higher polyvalent metal that has a lower ionization tendency than the metal of the monovalent metal salt C of the cleaning liquid.

Taking lithium (Li), potassium (K), and sodium (Na), which are monovalent metals, and calcium (Ca) and magnesium (Mg), which are polyvalent metals, as examples, if these are arranged in order from elements having a high ionization tendency to elements having a low ionization tendency, the order is as follows: Li>K>Ca>Na>Mg. Among these, lithium has the highest ionization tendency and magnesium has the lowest ionization tendency.

Examples of divalent or higher polyvalent metals include calcium (Ca), magnesium (Mg), aluminum (Al), yttrium (Y), copper (Cu), nickel (Ni), zinc (Zn), and barium (Ba). The ions of these polyvalent metals can be used as cations of the polyvalent meal salts.

The metal of the polyvalent metal salt A can be selected without any particular restriction from the divalent or higher polyvalent metals that have a lower ionization tendency than the metal of the monovalent metal salt C of the cleaning liquid. However, calcium or magnesium is more preferable as the metal of the polyvalent metal salt A because the reactivity tends to be higher if the ionic radius is small.

Examples of the anions of the polyvalent metal salt A include chloride ion (Cl⁻), nitrate ion (NO₃⁻), acetate ion (CH₃COO⁻), iodide ion (I⁻), bromide ion (Br⁻), chlorate ion (ClO₃⁻), and sulfate ion (SO₄²⁻). Examples of the polyvalent metal salt A include chloride, nitrate, acetate, iodide, bromide, chlorate, and sulfate.

Examples of the polyvalent metal salts A include calcium chloride, calcium nitrate, magnesium nitrate, copper nitrate, calcium acetate, and magnesium acetate.

The polyvalent metal salt A is preferably selected in consideration of the ionization tendency of the metal of the monovalent metal salt C contained in the cleaning liquid.

The pretreatment liquid may contain one of the above polyvalent metal salts A alone or two or more of the above polyvalent metal salts A.

The amount of the polyvalent metal salt A, expressed as the active component amount, relative to the total amount of the pretreatment liquid is preferably at least 1% by mass, more preferably at least 10% by mass, and even more preferably at least 15% by mass. The amount of the polyvalent metal salt A, expressed as the active component amount, relative to the total amount of the pretreatment liquid is preferably not more than 50% by mass, more preferably not more than 40% by mass, and even more preferably not more than 35% by mass. The amount of the polyvalent metal salt A, expressed as the active component amount, relative to the total amount of the pretreatment liquid is preferably 1 to 50% by mass, more preferably 10 to 40% by mass, and even more preferably 15 to 35% by mass.

In those cases where a metal salt hydrate is used as the metal salt in the present specification, the amount of the metal salt (the active component amount) refers to the equivalent amount of the anhydrous salt.

The pretreatment liquid may further contain a monovalent metal salt D.

The monovalent metal salt D can contain a monovalent metal. Examples of the monovalent metal include lithium (Li), potassium (K), and sodium (Na). The ions of these monovalent metals can be used as cations of the monovalent metal salts D.

Examples of the anions of the monovalent metal salts D include chloride ion (Cl⁻), nitrate ion (NO₃⁻), acetate ion (CH₃COO⁻), and sulfate ion (SO₄²⁻). Examples of the monovalent metal salt D include chloride, nitrate, acetate, iodide, bromide, chlorate, and sulfate.

Specific examples of the monovalent metal salt D includes lithium nitrate, potassium nitrate, sodium nitrate, lithium acetate, and sodium acetate.

The pretreatment liquid may contain one of these monovalent metal salts D alone or two or more of these monovalent metal salts D.

From the viewpoint of the jetting characteristics of the inkjet head (the stability within a printing device of the pretreatment liquid) after introducing the pretreatment liquid and leaving it for a long time, it is preferable that the monovalent metal salt D contain a metal with a higher ionization tendency than the polyvalent metal of the polyvalent metal salt A. From this point of view, it is more preferable that the monovalent metal salt D contain the same metal as the monovalent metal salt C of the cleaning liquid, for example. Suppose that the pretreatment liquid contains, as the monovalent metal salt D, a monovalent metal salt containing a metal with a higher ionization tendency than the polyvalent metal of the polyvalent metal salt A. In the above case, the monovalent metal salt D may act as a buffer, a decrease in pH may be suppressed, and the occurrence of rust and the like may be easily suppressed. In addition, in those cases in which the monovalent metal salt D contains a metal with a higher ionization tendency than the polyvalent metal of the polyvalent metal salt A, it is possible to reduce the amount of poorly water-soluble crystalline foreign matter derived from the polyvalent metal of the polyvalent metal salt A and exert a better cleaning effect. These can enhance the stability within the printing device of the pretreatment liquid.

From the viewpoint of the stability within the printing device of the pretreatment liquid, it is more preferable that the monovalent metal salt D contain a metal with a higher ionization tendency. The monovalent metal salt D preferably contains lithium or potassium, for example.

From the viewpoint of the stability within the printing device of the pretreatment liquid, nitrate ion is preferred as the anion of the monovalent metal salt D, and nitrate is preferred as the monovalent metal salt D. Nitric acid is generally deliquescent and nitrate tends to be highly soluble in water. Therefore, it is estimated that by forming relatively highly water-soluble nitrate from the poorly water-soluble crystalline foreign matter, the poorly water-soluble foreign matter may be reduced. By enhancing the cleaning properties, the nozzle of the head can be cleaned more easily. These may enhance the stability within the printing device of the pretreatment liquid.

It is preferable that the metal of the monovalent metal salt D be selected from metals with a higher ionization tendency than the metal of the polyvalent metal salt A. If the metal of the polyvalent metal salt A is calcium, the metal of the monovalent metal salt D is preferably lithium or potassium, for example. If the metal of the polyvalent metal salt A is magnesium, the metal of the monovalent metal salt D is preferably lithium, potassium, or sodium, for example.

More specific examples of metal combinations include a combination in which the polyvalent metal salt A contains calcium and the monovalent metal salt D contains lithium; a combination in which the polyvalent metal salt A contains calcium and the monovalent metal salt D contains potassium; a combination in which the polyvalent metal salt A contains magnesium and the monovalent metal salt D contains lithium; a combination in which the polyvalent metal salt A contains magnesium and the monovalent metal salt D contains potassium; and a combination in which the polyvalent metal salt A contains magnesium and the monovalent metal salt C contains sodium.

The amount of the monovalent metal salt D, expressed as the active component amount, relative to the total amount of the pretreatment liquid is preferably at least 0.01% by mass, more preferably at least 0.02% by mass, and even more preferably at least 0.03% by mass. The amount of the monovalent metal salt D, expressed as the active component, relative to the total amount of the pretreatment liquid is preferably not more than 1% by mass, more preferably not more than 0.5% by mass, and even more preferably not more than 0.3% by mass. The amount of the monovalent metal salt D, expressed as the active component amount, relative to the total amount of the pretreatment liquid is preferably 0.01 to 1% by mass, more preferably 0.02 to 0.5% by mass, and even more preferably 0.03 to 0.3% by mass.

The pretreatment liquid may contain the polyvalent metal salt A or a combination of the polyvalent metal salt A and the monovalent metal salt D as the metal salt. The total amount of metal salt in the pretreatment liquid, expressed as the active component amount relative to the total amount of the pretreatment liquid is preferably at least 1% by mass, more preferably at least 10% by mass, and even more preferably at least 15% by mass. The total amount of metal salt in the pretreatment liquid, expressed as the active component amount relative to the total amount of the pretreatment liquid is preferably not more than 50% by mass, more preferably not more than 40% by mass, and even more preferably not more than 35% by mass. The total amount of metal salt in the pretreatment liquid, expressed as the active component amount relative to the total amount of the pretreatment liquid is preferably 1 to 50% by mass, more preferably 10 to 40% by mass, and even more preferably 15 to 35% by mass.

The amount of the polyvalent metal salt A, expressed as the active component amount, relative to the total amount of metal salt of the pretreatment liquid (the active component amount) is preferably at least 90% by mass, more preferably at least 95% by mass, and may be 100% by mass.

If the pretreatment liquid contains the monovalent metal salt D, the amount of the monovalent metal salt D, expressed as the active component amount, relative to the total amount of metal salt of the pretreatment liquid (the active component amount) is preferably less than 10% by mass, and more preferably less than 5% by mass.

The pretreatment liquid preferably contains water, and the main solvent may be water.

There are no particular limitations on the water, but water containing as few ionic components as possible is preferred. Examples of the water include ion-exchanged water, distilled water, and ultrapure water.

From the viewpoint of viscosity adjustment, the amount of water contained relative to the total amount of the pretreatment liquid is preferably 20 to 80% by mass, more preferably 30 to 80% by mass, and even more preferably at 40 to 70% by mass.

The pretreatment liquid preferably contains a water-soluble organic solvent. Organic compounds that are liquids at room temperature and can be dissolved in water can be used as the water-soluble organic solvent, and the use of a water-soluble organic solvent that mixes uniformly with an equal volume of water at 1 atmosphere and 20° C. is preferred. Examples of water-soluble organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, 1-methyl-2-pyrrolidone, 1,3-dimethyl-2-imidazolidinone, β-thiodiglycol, and sulfolane. The boiling point of the water-soluble organic solvent is preferably at least 100° C., and more preferably 150° C. or higher.

One of these water-soluble organic solvents may be used alone, or a combination of two or more water-soluble organic solvents may be used provided that the solvents form a single phase with water.

The amount of the water-soluble organic solvent in the pretreatment liquid is preferably 5 to 50% by mass and more preferably 10 to 35% by mass.

The pretreatment liquid preferably contains a surfactant.

Examples of the surfactants that may be used include anionic surfactants, cationic surfactants, amphoteric surfactants, and nonionic surfactants, and one type or a combination of two or more types thereof may be used. Among these, nonionic surfactants are particularly preferred. The surfactant may be, for ex ample, a low-molecular weight surfactant or a polymer-based surfactant.

The HLB value of the surfactant is preferably 5 to 20 and more preferably 10 to 18.

Examples of nonionic surfactants include silicone-based surfactants, acetylene glycol-based surfactants, fluorine-based surfactants, polyoxyethylene alkyl ether-based surfactants, polyoxypropylene alkyl ether-based surfactants, polyoxyethylene alkyl phenyl ether-based surfactants, polyoxypropylene alkyl phenyl ether-based surfactants, polyoxyethylene fatty acid ester-based surfactants, polyoxypropylene fatty acid ester-based surfactants, sorbitan fatty acid ester-based surfactants, polyoxyethylene sorbitan fatty acid ester-based surfactants, polyoxyethylene sorbitol fatty acid ester-based surfactants, and glycerol fatty acid ester-based surfactants. One nonionic surfactant may be used alone or a combination of two or more nonionic surfactants may be used

Among these, a silicone-based surfactant, an acetylene glycol-based surfactant, or a combination of these is preferred, and an acetylene glycol-based surfactant is more preferred.

Examples of commercially available products of an acetylene glycol-based surfactant include, for example, “ACETYLENOL E60” (product name) manufactured by Kawaken Fine Chemicals Co., Ltd.

One of the above surfactants may be used alone or a combination of two or more may be used.

The amount of the surfactant, expressed as the active component amount, relative to the total amount of the pretreatment liquid is preferably 0.1 to 5% by mass, more preferably 0.5 to 3% by mass, and even more preferably 0.5 to 2% by mass.

The pretreatment liquid may contain an additive, if necessary. Examples of additives include antioxidants, UV absorbers, infrared absorbers, and crosslinking agents. One of these additives may be used alone, or a combination of two or more of these additives may be used.

In order to obtain jetting properties suitable for an inkjet method, the viscosity of the pretreatment liquid at 23° C. is preferably 1 to 30 mPa s, more preferably 3 to 20 mPa s, and even more preferably 4 to 12 mPa s.

The pH of the pretreatment liquid is preferably 3 to 10 and more preferably 4 to 8.

The method for producing the pretreatment liquid is not particularly limited, but a desired pretreatment liquid can be obtained by mixing together the components appropriately. The resulting composition may be filtered by using a filter or the like. Further, various additives may also be added as appropriate.

The pretreatment liquid can be applied to the substrate by means of an inkjet method. The inkjet method is not particularly limited and may be any method such as a piezo method, an electrostatic method, or a thermal method. When an inkjet printing device is used, it is preferable that the pretreatment liquid be jetted from an inkjet head based on a digital signal, and the liquid droplets of the jetted pretreatment liquid be adhered to the substrate.

The pretreatment liquid is preferably applied to the substrate prior to printing using an aqueous ink.

### Aqueous Inkjet Ink

An ink set of one embodiment can contain an aqueous ink.

The aqueous ink preferably contains a colorant.

The aqueous ink may contain a pigment, a dye, or a combination thereof as the colorant.

Examples of dyes that can be used favorably as the dye include water-soluble dyes and dyes that have been made water-soluble by reduction or the like, selected from among basic dyes, acid dyes, direct dyes, soluble vat dyes, acid mordant dyes, mordant dyes, reactive dyes, vat dyes, and sulfide dyes. Further, dispersible dyes such as azo-based dyes, anthraquinone-based dyes, azomethine-based dyes, and nitro-based dyes can also be used favorably. One of these dyes may be used alone, or a combination of a plurality of dyes may be used.

The pigment can be preferably blended into the ink as a pigment dispersion.

Examples of the pigment dispersion that can be used include one in which a pigment is dispersed in water with a pigment dispersant, one in which a self-dispersing pigment is dispersed in water, and one in which a microencapsulated pigment obtained by coating the pigment with resins is dispersed in water.

Examples of the pigment which can be used include organic pigments such as azo pigments, phthalocyanine pigments, polycyclic pigments, and dye lake pigments, and inorganic pigments such as carbon blacks and metal oxides. Examples of azo pigments include soluble azo lake pigments, insoluble azo pigments, and condensed azo pigments. Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black. Examples of metal oxides include titanium dioxide and zinc oxide. One of these pigments may be used alone or a combination of two or more of these pigments may be used.

From the viewpoints of the jetting stability and the storage stability, the average particle size of the pigment particles in the ink, expressed as the volume-based average value in a particle size distribution measured by means of a dynamic light scattering method, is preferably not more than 300 nm, more preferably not more than 150 nm, and even more preferably not more than 100 nm.

A self-dispersing pigment may be used as a colorant. A self-dispersing pigment is a pigment in which a hydrophilic functional group has been introduced at the pigment surface by a chemical treatment or a physical treatment. The hydrophilic functional group introduced into the self-dispersing pigment is preferably a group that has ionicity, and by charging the pigment surface either anionically or cationically, the pigment particles can be stably dispersed in water by electrostatic repulsion. Examples of preferable anionic functional groups include carboxyl groups, sulfo groups, sulfino groups, sulfuric acid ester groups, phosphoric acid groups, phosphoric acid ester groups, phosphorous acid groups, and phosphorous acid ester groups. Preferred cationic functional groups include quaternary ammonium groups, and quaternary phosphonium groups.

These hydrophilic functional groups may be bonded directly to the pigment surface or bonded via another atom grouping. Examples of this other atom grouping include, but are not limited to, alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

Preferable examples of the self-dispersing pigment include “CAB-O-JET 200”, “CAB-O-JET 300”, “CAB-O-JET 250C” “CAB-O-JET 260M”, “CAB-O-JET 270”, “CAB-O-JET 400”, “CAB-O-JET 450C”, “CAB-O-JET 465M”, and “CAB-O-JET 470Y” of the CAB-O-JET series manufactured by Cabot Corporation, and “BONJET BLACK CW-1”, “BONJET BLACK CW-2”, and “BONJET BLACK CW-4” manufactured by Orient Chemical Industries Co., Ltd. (all product names).

From the viewpoints of the print density and the ink viscosity, the amount of the colorant in the aqueous ink relative to the total amount of the aqueous ink is preferably 0.1 to 20% by mass, more preferably 1 to 15% by mass, even more preferably 1 to 10% by mass, even more preferably 2 to 8% by mass, and even more preferably 2 to 6% by mass.

A pigment dispersant typified by polymeric dispersants and surfactants may be preferably used for the pigment to be stably dispersed in the ink.

One pigment dispersant may be used alone or a combination of two or more may be used.

In cases where a pigment dispersant is used, the amount of the pigment dispersant added varies depending on the type used and there are no particular limitations thereon. For example, the pigment dispersant, expressed as a mass ratio of the active component relative to a value of 1 for the pigment, can be added in an amount within a range of 0.005 to 0.2.

The aqueous ink preferably contains a surfactant.

Examples of surfactants that may be preferably used include anionic surfactants, cationic surfactants, amphoteric surfactants, and nonionic surfactants, and one type or a combination two or more types thereof may be used. Among these, nonionic surfactants are particularly preferred. The surfactant may be, for example, a low-molecular weight surfactant or a polymer-based surfactant.

The HLB value of the surfactant is preferably 5 to 20 and more preferably 10 to 18.

Examples of the surfactant that may be used include those describe above in relation to the pretreatment liquid, and the surfactant may be selected from among those describe above in relation to the pretreatment liquid. A nonionic surfactant is preferred as the surfactant, and a silicone-based surfactant, an acetylene glycol-based surfactant, or a combination of these is more preferred.

A single surfactant may be used, or a combination of two or more surfactants may be used.

The amount of the surfactant, expressed as the active component amount, relative to the total amount of the ink is preferably 0.1 to 5% by mass, more preferably 0.5 to 3% by mass, and even more preferably 0.5 to 2% by mass.

The aqueous ink may also contain a binder resin. Examples of the binder resin include a water-dispersible resin, a water-soluble resin, and a combination thereof. The binder resin may be any of an anionic resin, a cationic resin, an amphoteric resin, and a nonionic resin, but an anionic resin, a nonionic resin, or a combination thereof is preferable.

Water-dispersible resins are preferred as the binder resins. The water-dispersible resins can be dispersed in water without being dissolved in water and form an oil-in-water (O/W) type emulsion. The water-dispersible resin is preferably contained in the aqueous ink in a dispersed state as resin particles. The water-dispersible resin may, for example, be blended into the aqueous ink in the form of a resin emulsion.

The average particle size of the water-dispersible resins (an average particle size measured on a volume basis by means of a dynamic light scattering method) is preferably 1 nm to 300 nm, more preferably 5 to 200 nm, and even more preferably 10 to 150 nm.

In terms of the type of water-dispersible resin used, the use of a resin that forms a transparent coating film is preferred.

Examples of the water-dispersible resins include: conjugated diene resins such as styrene-butadiene copolymers, methyl methacrylate-butadiene copolymers, and vinyl chloride-vinyl acetate copolymers; acrylic-based resins such as polymers of acrylic acid esters and/or methacrylic acid esters, or copolymers thereof with styrene or the like; vinyl-based resins such as ethylene-vinyl acetate copolymers, or functional-group modified resins based on monomers containing functional groups such as carboxyl groups of these various resins; melamine resins; urea resins; polyurethane resins; unsaturated polyester resins; polyolefin resins; silicone resins; polyvinyl butyral resins; and alkyd resins. A water-dispersible resin of one of these resins may be used, but a hybrid water-dispersible resin may also be used.

One of these water-dispersible resins may be used alone, or a combination of two or more water-dispersible resins may be used.

The amount (solid fraction) of the water-dispersible resin in the ink is preferably 0.5 to 20% by mass, more preferably 1 to 20% by mass, and even more preferably 5 to 10% by mass.

One of the binder resins described above may be used alone or a combination of two or more may be used.

The amount of the binder resin relative to the total amount of ink is preferably 0.5 to 20% by mass, more preferably 1 to 20% by mass, and even more preferably 5 to 10% by mass.

The aqueous ink preferably contains water, and the main solvent may be water.

There are no particular limitations on the water, but it is preferably water in which the ionic components are as minimal as possible. In particular, from the viewpoint of the pigment dispersion stability of the ink, the amount contained of polyvalent metal ions such as calcium is preferably small. For example, ion-exchanged water, distilled water, ultrapure water, or the like may be used as the water.

From the viewpoint of viscosity adjustment, the amount of water contained relative to the total amount of ink is preferably 20 to 90% by mass, more preferably 30 to 80% by mass, and even more preferably 40 to 70% by mass.

The aqueous ink preferably contains a water-soluble organic solvent. Organic compounds that are liquids at room temperature and can be dissolved in water can be used as the water-soluble organic solvent. It is preferable to use a water-soluble organic solvent that mixes uniformly with an equal volume of water at 1 atmosphere and 20° C. As the water-soluble organic solvent, those described above for the pretreatment liquid can be used, for example. One of these water-soluble organic solvents may be used alone, or a combination of two or more water-soluble organic solvents may be used provided that the solvents form a single phase with water.

From the viewpoints of wettability, moisture retention effect, viscosity adjustment, and the like, the amount of water-soluble organic solvent contained relative to the total amount of the ink may be 1 to 80% by mass, more preferably 10 to 50% by mass, and more preferably 20 to 40% by mass.

The aqueous ink may contain an additive, if necessary. Examples of additives include antioxidants, UV absorbers, infrared absorbers, and crosslinking agents. One of these additives may be used alone, or a combination of two or more of these additives may be used.

In order to obtain jetting properties suitable for an inkjet ink, the viscosity of the aqueous ink at 23° C. is preferably 1 to 40 mPa·s, more preferably 3 to 20 mPa·s, and even more preferably 4 to 12 mPa·s.

The method for producing the ink is not particularly limited, but a desired ink can be obtained by mixing together the components in an appropriate manner. For example, a dispersion device such as a beads mill may be used to enhance pigment dispersion. Further, the obtained composition may be filtered using a filter or the like. Furthermore, various additives may be added as appropriate.

The aqueous ink can be applied to a substrate by means of an inkjet method. The inkjet method is not particularly limited and may be any method such as a piezo method, an electrostatic method, or a thermal method. When an inkjet printing device is used, it is preferable that the pretreatment liquid be jetted from an inkjet head based on a digital signal, and the liquid droplets of the jetted pretreatment liquid are adhered to the substrate.

The aqueous ink is preferably applied to the substrate to which the pretreatment liquid has been applied.

### Cleaning Liquid

The ink set of one embodiment can contain a cleaning liquid.

The cleaning liquid can contain water, a water-soluble organic solvent B with an SP value of at least 11 (cal/cm^{3)1/2} (hereinafter sometimes simply referred to as “water-soluble organic solvent B”), and a monovalent metal salt C.

The cleaning liquid may contain the water-soluble organic solvent B.

As the water-soluble organic solvent B, organic compounds that are liquids at room temperature and can be dissolved in water and has an SP value of at least 11 (cal/cm^{3)1/2} can be used. As the water-soluble organic solvent B, it is preferable to use a water-soluble organic solvent that mixes uniformly with an equal volume of water at 1 atmosphere and 20° C. The boiling point of the water-soluble organic solvent B is preferably at least 100° C. and more preferably at least 150° C.

The SP value is a solubility parameter, which attempts to determine solubility by the change in the aggregation energy. Since the aggregation energy of a liquid is equivalent to the enthalpy of vaporization, the dissolution parameter δ can be defined as in following formula (1) from the molar heat of vaporization ΔHv and the molecular volume V. By using this formula, the SP value can be calculated from the heat of vaporization required for 1 molar volume of liquid to vaporize.

δ(SP value)={(ΔH^{v}−RT)/V}^{1/2} Formula (1)

In formula (1), AH indicates the heat of vaporization and V indicates the molecular volume (see “Youkaisei Parameter Tekiyo Jirei-syu (Case Studies of Application of Solubility Parameter)” (based on examples of evaluation and calculation of mechanism and solubility), pages 52 to 54, JOHOKIKO Co., LTD., published on Mar. 15, 2007).

The SP value of the water-soluble organic solvent B is preferably at least 11 (cal/cm^{3)1/2}. From the viewpoint of better cleaning properties for an ink, the SP value of the water-soluble organic solvent B is more preferably at least 12 (cal/cm^{3)1/2}, even more preferably at least 14 (cal/cm^{3)1/2}, and even more preferably at least 15 (cal/cm^{3)1/2}.

Examples of the water-soluble organic solvent B include glycerol, 1,2-propanediol, 1,3-propanediol, diethylene glycol, triethylene glycol, 1,2-hexanediol, 1,4-butanediol, and 1,5-pentanediol.

One of these water-soluble organic solvents B may be used alone or a combination of two or more water-soluble organic solvents may be used provided that the solvents form a single phase with water.

The amount of the water-soluble organic solvent B relative to the total amount of the cleaning liquid is preferably at least 5% by mass. From the viewpoint of further enhancing the stability within a printing device of the cleaning liquid, the amount of the water-soluble organic solvent B relative to the total amount of the cleaning liquid is more preferably at least 10% by mass and even more preferably at least 20% by mass. Meanwhile, the amount of the water-soluble organic solvent B relative to the total amount of the cleaning liquid is preferably not more than 50% by mass. From the viewpoint of further enhancement in storage stability, the amount of the water-soluble organic solvent B relative to the total amount of the cleaning liquid is more preferably not more than 40% by mass and even more preferably not more than 35% by mass. The amount of the water-soluble organic solvent B relative to the total amount of the cleaning liquid is preferably 5 to 50% by mass, more preferably 10 to 40% by mass, and even more preferably 20 to 35% by mass.

The cleaning liquid may contain a water-soluble organic solvent other than the water-soluble organic solvent B.

The amount of the water-soluble organic solvent B relative to the total amount of water-soluble organic solvent in the cleaning liquid is preferably at least 50% by mass, more preferably at least 70% by mass, even more preferably at least 90% by mass, even more preferably at least 95% by mass, and may be 100% by mass.

The cleaning liquid may contain the monovalent metal salt C. The monovalent metal salt C can contain monovalent metal with a higher ionization tendency than the metal of the polyvalent metal salt A of the pretreatment liquid.

Examples of the metal of the monovalent metal salt C include lithium, potassium, and sodium. The ions of these monovalent metals can be used as cations in the monovalent metal salts C.

Examples of the anions of the monovalent metal salt C include chloride ion (Cl⁻), nitrate ion (NO₃⁻), acetate ion (CH₃COO⁻), and sulfate ion (SO₄²⁻). Examples of the monovalent metal salt C include chloride, nitrate, acetate, iodide, bromide, chlorate, and sulfate.

The metal of the monovalent metal salt C can be selected without any particular restriction from monovalent metals that have a higher ionization tendency than the metal of the polyvalent metal salt A of the pretreatment liquid. However, from the viewpoint of better cleaning properties, it is preferable that the monovalent metal salt C contain a metal with a higher ionization tendency. The monovalent metal salt C preferably contains lithium or potassium, for example. If the monovalent metal salt C contains lithium or potassium, a better cleaning effect may be exerted, especially for the pretreatment liquid.

In particular, from the viewpoint of better cleaning properties for the pretreatment liquid, the nitrate ion is preferred as the anion of the monovalent metal salt C, and the nitrate is preferred as the monovalent metal salt C. Nitric acid is generally deliquescent and nitrate tends to be highly soluble in water. Therefore, it is estimated that by forming relatively highly water-soluble nitrate from the poorly water-soluble crystalline foreign matter, the poorly water-soluble foreign matter may be reduced, and the cleaning properties may be enhanced,

Specific examples of the monovalent metal salt C include lithium nitrate, potassium nitrate, sodium nitrate, lithium acetate, and sodium acetate.

The metal of the monovalent metal salt C can be selected from metals with a higher ionization tendency than the metal of the polyvalent metal salt A of the pretreatment liquid. If the metal of the polyvalent metal salt A of the pretreatment liquid is calcium, the metal of the monovalent metal salt C is preferably lithium or potassium, for example. If the metal of the polyvalent metal salt A of the pretreatment liquid is magnesium, the metal of the monovalent metal salt C is preferably lithium, potassium, or sodium, for example.

More specific examples of metal combinations include a combinations in which the polyvalent metal salt A contains calcium and the monovalent metal salt C contains lithium; a combination in which the polyvalent metal salt A contains calcium and the monovalent metal salt C contains potassium; a combination in which the polyvalent metal salt A contains magnesium and the monovalent metal salt C contains lithium; a combination in which the polyvalent metal salt A contains magnesium and the monovalent metal salt C contains potassium; and a combination in which the polyvalent metal salt A contains magnesium and the monovalent metal salt C contains sodium.

The cleaning liquid may contain one of these monovalent metal salts C alone or two or more of these monovalent metal salts C.

The amount of the monovalent metal salt C, expressed as the active component amount, relative to the total amount of the cleaning liquid is preferably at least 0.01% by mass, more preferably at least 0.02% by mass, and even more preferably at least 0.03% by mass. The amount of the monovalent metal salt C, expressed as the active component amount, relative to the total amount of the cleaning liquid is preferably not more than 1% by mass, more preferably not more than 0.5% by mass, and even more preferably not more than 0.3% by mass. The amount of the monovalent metal salt C, expressed as the active component amount, relative to the total amount of the cleaning liquid is preferably 0.01 to 1% by mass, more preferably 0.02 to 0.5% by mass, and even more preferably 0.03 to 0.3% by mass.

The cleaning liquid may contain a metal salt other than the monovalent metal salt C as metal salts.

The amount of the monovalent metal salt C, expressed as the active component amount, relative to the total amount of metal salts in the cleaning liquid (the active component amount) is preferably at least 90% by mass, more preferably at least 95% by mass, even more preferably at least 99% by mass, and may be 100% by mass. Meanwhile, the cleaning liquid may contain a polyvalent metal salt. However, the amount of the polyvalent metal salt, expressed as the active component amount, relative to the total amount of the cleaning liquid is preferably not more than 1% by mass, more preferably not more than 0.5% by mass, and even more preferably 0% by mass. The amount of polyvalent metal salt, expressed as the active component amount, relative to the total amount of metal salt in the cleaning liquid (the active component amount) is preferably not more than 10% by mass, more preferably not more than 5% by mass, even more preferably not more than 1% by mass, and may be 0% by mass.

The cleaning liquid preferably contains water, and the main solvent may be water.

There are no particular limitations on the water, but water containing as few ionic components as possible is preferred. Examples of the water include ion-exchanged water, distilled water, and ultrapure water.

The amount of water relative to the total amount of the cleaning liquid is preferably 20 to 90% by mass, more preferably 30 to 80% by mass, and even more preferably 40 to 70% by mass.

The cleaning liquid preferably contains a surfactant.

Examples of the surfactants that may be used include anionic surfactants, cationic surfactants, amphoteric surfactants, and nonionic surfactants, and one type or a combination of two or more types thereof may be used. Among these, nonionic surfactants are particularly preferred. The surfactant may be, for example, a low-molecular weight surfactant or a polymer-based surfactant.

The HLB value of the surfactant is preferably 5 to 20 and more preferably 10 to 18.

Examples of the surfactant that may be used include those describe above in relation to the pretreatment liquid, and the surfactant may be selected from among those describe above in relation to the pretreatment liquid. A nonionic surfactant is preferred as the surfactant, and a silicone-based surfactant, an acetylene glycol-based surfactant, or a combination of these is more preferred.

A single surfactant may be used, or a combination of two or more surfactants may be used.

The amount of the surfactant, expressed as the active component amount, relative to the total amount of ink is preferably 0.1 to 5% by mass, more preferably 0.5 to 3% by mass, and even more preferably 0.5 to 2% by mass,.

The cleaning liquid may contain an additive, if necessary. Examples of additives include antioxidants, UV absorbers, infrared absorbers, and crosslinking agents. One of these additives may be used alone, or a combination two or more of these additives may be used.

The viscosity of the cleaning liquid at 23° C. is preferably 1 to 30 mPa˜s, more preferably 3 to 20 mPa·s, and even more preferably 4 to 12 mPa·s.

The pH of the cleaning liquid is preferably 5 to 9 and more preferably 6 to 8.

The method for producing the cleaning liquid is not particularly limited, but a desired cleaning liquid can be obtained by mixing together the components appropriately. The resulting composition may be filtered by using a filter or the like. Further, various additives may also be added as appropriate.

The cleaning liquid can be used for cleaning, for example, an inkjet head and a path. The cleaning liquid may be applied to the nozzle face of the inkjet head or the path of the ink and/or pretreatment liquid, for example.

In the cleaning operation of the inkjet head, the nozzle face may be cleaned using a cleaning liquid, for example. Examples of such cleaning operations include a method of applying a cleaning liquid to the nozzle face, a method of applying a cleaning liquid to the nozzle face and wiping the nozzle face using a wiper, and a method of wiping the nozzle face using a wiper to which a cleaning liquid has been applied.

The cleaning operation may be performed immediately before printing, immediately after printing, or both. The cleaning operation may be performed when a sensor or the like senses dirt on the nozzle face after printing a prescribed number of times.

For the cleaning operation, a container of a cleaning liquid and a cleaning mechanism such as a wiper may be provided in the inkjet printing device.

As another method, the dirt on the nozzle face may be manually wiped by using a cleaning liquid when the nozzle face becomes dirty, or the nozzle face may be immersed in the cleaning liquid to dissolve and remove the ink. The path may also be cleaned by introducing a cleaning liquid into the container of the pretreatment liquid or ink.

### Ink Set

The ink set can contain at least the above-described pretreatment liquid, aqueous ink, and cleaning liquid. The ink set may contain two or more aqueous inks, for example. The ink set may contain a post-treatment liquid, or the like.

### EXAMPLES

The present invention will be described below in further detail using a series of examples, but the present invention is in no way limited by the following examples. In the following description, “%” represents “% by mass” unless specifically stated otherwise. With respect to the materials in the form of a solution, dispersion, or the like, the amounts shown in each table indicate the total amount of the materials (in the form of a solution, dispersion, or the like), and the proportions of the resin fraction, active components, or the like are also shown.

### Production of Metal Salt Aqueous Solution

### Calcium Acetate Solution

A calcium acetate solution was prepared by dissolving calcium acetate monohydrate, manufactured by FUJIFILM Wako Pure Chemical Corporation, in ion-exchanged water such that a 30%-by-mass aqueous solution was obtained in terms of anhydrate.

### Magnesium Acetate Solution

A magnesium acetate solution was prepared by dissolving magnesium acetate tetrahydrate, manufactured by FUJIFILM Wako Pure Chemical Corporation, in ion-exchanged water such that a 30%-by-mass aqueous solution was obtained in terms of anhydrate.

### Lithium Nitrate Solution

A lithium nitrate solution was prepared by dissolving lithium nitrate, manufactured by FUJIFILM Wako Pure Chemical Corporation, in ion-exchanged water such that a 10%-by-mass aqueous solution was obtained in terms of anhydrate.

### Potassium Nitrate Solution

A potassium nitrate solution was prepared by dissolving potassium nitrate, manufactured by FUJIFILM Wako Pure Chemical Corporation, in ion-exchanged water such that a 10%-by-mass aqueous solution was obtained in terms of anhydrate.

### Sodium Nitrate Solution

A sodium nitrate solution was prepared by dissolving sodium nitrate, manufactured by FUJIFILM Wako Pure Chemical Corporation, in ion-exchanged water such that a 10%-by-mass aqueous solution was obtained in terms of anhydrate.

### Lithium Acetate Solution

A lithium acetate solution was prepared by dissolving lithium acetate, manufactured by FUJIFILM Wako Pure Chemical Corporation, in ion-exchanged water such that a 10%-by-mass aqueous solution was obtained in terms of anhydrate.

### Sodium Acetate Solution

A sodium acetate solution was prepared by dissolving sodium acetate, manufactured by FUJIFILM Wako Pure Chemical Corporation, in ion-exchanged water such that a 10%-by-mass aqueous solution was obtained in terms of anhydrate.

### Production of Pretreatment Liquid, Ink, and Cleaning Liquid

Table 1 shows the formulations of pretreatment liquids 1 to 6. Table 2 shows the formulation of ink 1. Tables 3 and 4 show the formulations of cleaning liquids 1 to 12. The raw materials were mixed according to the formulations shown in the tables, stirred at 100 rpm for 30 minutes using a mix rotor, and filtered through a 5-μm nylon syringe filter to prepare the pretreatment liquids 1 to 6, the ink 1, and the cleaning liquids 1 to 12 individually.

The unit of the SP value for water-soluble organic solvents shown in Tables 1 to 7 is “(cal/cm^{3)1/2}”.

In Tables 1 to 7, “PTL 1” to “PTL 6” respectively represent “pretreatment liquid 1” to “pretreatment liquid 6”, “CL 1” to “CL 12” respectively represent “cleaning liquid 1” to “cleaning liquid 12”, “Ex 1” to “Ex 13” respectively represent “Example 1” to “Example 13”, and “C Ex 1” to “C Ex 6” respectively represent “Comparative Example 1” to “Comparative Example 6”.

Details of the materials shown in Tables 1 to 4 are described below.

### Polyvalent Metal Salts

Calcium acetate solution: produced as above, calcium acetate (in terms of anhydrate) 30% by mass

Magnesium acetate solution: produced as above, magnesium acetate (in terms of anhydrate): 30% by mass

### Monovalent Metal Salts

Lithium nitrate solution: produced as above, lithium nitrate (in terms of anhydrate) 10% by mass

Potassium nitrate solution: produced as above, potassium nitrate (in terms of anhydrate) 10% by mass

Sodium nitrate solution: produced as above, sodium nitrate (in terms of anhydrate) 10% by mass

Lithium acetate solution: produced as above, lithium acetate (in terms of anhydrate) 10% by mass

Sodium acetate solution: produced as above, sodium acetate (in terms of anhydrate) 10% by mass

### Water-Soluble Organic Solvents

Glycerol: manufactured by FUJIFILM Wako Pure Chemical Corporation, SP value 16.7 (cal/cm^{3)1/2}

Diethylene glycol: manufactured by FUJIFILM Wako Pure Chemical Corporation, SP value 11.2 (cal/cm^{3)1/2}

Tetraethylene glycol: Manufactured by FUJIFILM Wako Pure Chemical Corporation, SP value 9.8 (cal/cm^{3)1/2}

### Surfactant

“ACETYLENOL 60” (product name): manufactured by Kawaken Fine Chemicals Co., Ltd., acetylene glycol-based surfactant

### Self-Dispersing Pigment

“CAB-O-JET 400” (product name): manufactured by Cabot Corporation, solid fraction: 15% by mass

### Binder Resin

“NeoRezR-967” (product name): anionic urethane resin emulsion, manufactured by Covestro Coating Resins, Inc., LLC, resin fraction: 40% by mass

TABLE 1
Formulation of pretreatment liquid

| | | Solid- | SP- | PTL | PTL | PTL | PTL | PTL | PTL |
|---|---|---|---|---|---|---|---|---|---|
| (% by mass) | | fraction | value | 1 | 2 | 3 | 4 | 5 | 6 |
| Polyvalent- | Calcium acetate- | 30% | | 66.7 | | 66.7 | 66.7 | 66.7 | 66.7 |
| metal salt | solution | | | | | | | | |
| | Magnesium | 30% | | | 66.7 | | | | |
| | acetate-solution | | | | | | | | |
| Monovalent- | Lithium nitrate- | 10% | | | | 0.5 | | | |
| metal salt | solution | | | | | | | | |
| | Sodium nitrate- | 10% | | | | | 0.5 | | |
| | solution | | | | | | | | |
| | Lithium acetate | 10% | | | | | | 0.5 | |
| | solution | | | | | | | | |
| | Sodium acetate- | 10% | | | | | | | 0.5 |
| | solution | | | | | | | | |
| Water- | Glycerol | | 16.7 | 1.0 | 1.0 | 1.0 | 1.0 | 1.0 | 1.0 |
| soluble- | Diethylene | | 11.2 | 20.0 | 20.0 | 20.0 | 20.0 | 20.0 | 20.0 |
| organic- | glycol | | | | | | | | |
| solvent | | | | | | | | | |
| Surfactant | ACETYLENOL | | | 1.0 | 1.0 | 1.0 | 1.0 | 1.0 | 1.0 |
| | E60 | | | | | | | | |
| Water | Ion-exchanged | | | 11.3 | 11.3 | 10.8 | 10.8 | 10.8 | 10.8 |
| | water | | | | | | | | |

| | | | | | | |
|---|---|---|---|---|---|---|
| Total (% by mass) | 100 | 100 | 100 | 100 | 100 | 100 |

TABLE 2
Formulation of ink

| | | Solid- | SP | |
|---|---|---|---|---|
| (% by mass) | | fraction | value | Ink 1 |
| Self- | CAB-O-JET 400 | 15% | | 20 |
| dispersing- | | | | |
| pigment | | | | |
| Binder resin | NeoRezR-967 | 40% | | 22.5 |
| Water- | Glycerol | | 16.7 | 1 |
| soluble- | Diethylene glycol | | 11.2 | 30 |
| organic | | | | |
| solvent | | | | |
| Surfactant | ACETYLENOL E60 | | | 1 |
| Water | Ion-exchanged water | | | 25.5 |

| | |
|---|---|
| Total (% by mass) | 100 |

TABLE 3
Formulation of cleaning liquid

| | | Solid- | SP- | CL | CL | CL | CL | CL | CL |
|---|---|---|---|---|---|---|---|---|---|
| (% by mass) | | fraction | value | 1 | 2 | 3 | 4 | 5 | 6 |
| Polyvalent- | Calcium acetate- | 30% | | | | | | | |
| metal salt | solution | | | | | | | | |
| Monovalent- | Lithium nitrate- | 10% | | 0.5 | | | 0.5 | | |
| metal salt | solution | | | | | | | | |
| | Potassium | 10% | | | 0.5 | | | 0.5 | |
| | nitrate-solution | | | | | | | | |
| | Sodium nitrate- | 10% | | | | 0.5 | | | 0.5 |
| | solution | | | | | | | | |
| | Lithium acetate- | 10% | | | | | | | |
| | solution | | | | | | | | |
| | Sodium acetate- | 10% | | | | | | | |
| | solution | | | | | | | | |
| Water-soluble- | Glycerol | | 16.7 | 30 | 30 | 30 | | | |
| solvent | Diethylene glycol | | 11.2 | | | | 30 | 30 | 30 |
| | Tetraethylene- | | 9.8 | | | | | | |
| | glycol | | | | | | | | |
| Surfactant | ACETYLENOL- | | | 1 | 1 | 1 | 1 | 1 | 1 |
| | E60 | | | | | | | | |
| Water | Ion-exchanged- | | | 68.5 | 68.5 | 68.5 | 68.5 | 68.5 | 68.5 |
| | water | | | | | | | | |

| | | | | | | |
|---|---|---|---|---|---|---|
| Total (% by mass) | 100 | 100 | 100 | 100 | 100 | 100 |

TABLE 4
Formulation of cleaning liquid

| | | Solid- | SP- | CL | CL | CL | CL | CL | CL |
|---|---|---|---|---|---|---|---|---|---|
| (% by mass) | | fraction | value | 7 | 8 | 9 | 10 | 11 | 12 |
| Polyvalent- | Calcium acetate- | 30% | | | | | | | 1.7 |
| metal salt | solution | | | | | | | | |
| Monovalent- | Lithium nitrate- | 10% | | 0.5 | | | | | |
| metal salt | solution | | | | | | | | |
| | Potassium | 10% | | | 0.5 | | | | |
| | nitrate-solution | | | | | | | | |
| | Sodium nitrate- | 10% | | | | 0.5 | | | |
| | solution | | | | | | | | |
| | Lithium acetate- | 10% | | | | | 0.5 | | |
| | solution | | | | | | | | |
| | Sodium acetate- | 10% | | | | | | 0.5 | |
| | solution | | | | | | | | |
| Water-soluble- | Glycerol | | 16.7 | | | | 30 | 30 | 30 |
| organic- | Diethylene glycol | | 11.2 | | | | | | |
| solvent | Tetraethylene- | | 9.8 | 30 | 30 | 30 | | | |
| | glycol | | | | | | | | |
| Surfactant | ACETYLENOL- | | | 1 | 1 | 1 | 1 | 1 | 1 |
| | E60 | | | | | | | | |
| Water | Ion-exchanged- | | | 68.5 | 68.5 | 68.5 | 68.5 | 68.5 | 69 |
| | water | | | | | | | | |

| | | | | | | |
|---|---|---|---|---|---|---|
| Total ( % by mass) | 100 | 100 | 100 | 100 | 100 | 100 |

### Evaluation

### Mixing Stability

The mixing stability was evaluated as an indicator of the cleaning properties. The cleaning liquid, and the ink or the pretreatment liquid were mixed at a mass ratio of 1:1. After the mixture was left at 60° C. for 1 month, whether foreign matter occurred in the mixture was observed by using a laser microscope, and evaluations were made according to the following criteria. Tables 5 to 7 show the results.

### Evaluation Criteria

A: No foreign matter is observed

B: Foreign matter is observed but the amount is not a problem in actual use

C: Foreign matter can be observed over the entire surface under a microscope

### Stability Within Device

A shuttle-type inkjet printer with 300 npi resolution mounted with a piezoelectric print head was prepared and filled with the pretreatment liquid.

After leaving the printer at 50° C. for 1 week in a capped state, cleaning was performed (a small amount of ink was jetted, suction was performed by using a suction machine, and then the deposit around the nozzle was wiped), thereafter the pretreatment liquid was jetted, and the number of nozzle misfires (the number of non-jetting nozzles) was counted. The evaluation was performed according to the following criteria. Tables 5 to 7 show the results

### Evaluation Criteria

A: The number of nozzle misfires after the cleaning operation relative to the total number of nozzles is less than 1%

B: The number of nozzle misfires after the cleaning operation relative to the total number of nozzles is less than 3%

C: The number of nozzle misfires after the cleaning operation relative to the total number of nozzles is at least 3%

TABLE 5

| | | Ex 1 | Ex 2 | Ex 3 | Ex 4 | Ex 5 | Ex 6 | Ex 7 |
|---|---|---|---|---|---|---|---|---|
| Cleaning liquid | | CL 1 | CL 1 | CL 1 | CL 1 | CL 2 | CL 2 | CL 3 |
| Cleaning | Monovalent- | Li ion | Li ion | Li ion | Li ion | K ion | K ion | Na ion |
| liquid | metal-salt- | | | | | | | |
| | cation | | | | | | | |
| | Monovalent- | NO₃ | NO₃ | NO₃ | NO₃ | NO₃ | NO₃ | NO₃ |
| | metal-salt- | ion | ion | ion | ion | ion | ion | ion |
| | anion | | | | | | | |
| | Water- | 16.7 | 16.7 | 16.7 | 16.7 | 16.7 | 16.7 | 16.7 |
| | soluble- | | | | | | | |
| | organic- | | | | | | | |
| | solvent | | | | | | | |
| | SP value | | | | | | | |
| Ink | | Ink 1 | Ink 1 | Ink 1 | Ink 1 | Ink 1 | Ink 1 | Ink 1 |
| Pretreatment liquid | | PTL 3 | PTL 1 | PTL 4 | PTL 5 | PTL 1 | PTL 2 | PTL 2 |
| Pre- | Polyvalent | Ca ion | Ca ion | Ca ion | Ca ion | Ca ion | Mg ion | Mg ion |
| treatment | metal-salt- | | | | | | | |
| liquid | cation | | | | | | | |
| | Monovalent- | Li ion | — | Na ion | Li ion | — | — | — |
| | metal-salt- | | | | | | | |
| | cation | | | | | | | |
| | Monovalent- | NO₃ | — | NO₃ | CH₃COO | — | — | — |
| | metal-salt- | ion | | ion | ion | | | |
| | anion | | | | | | | |
| Mixing | Ink | A | A | A | A | A | A | A |
| stability | Pretreatment- | A | A | A | A | A | A | B |
| | liquid | | | | | | | |

| | | | | | | | |
|---|---|---|---|---|---|---|---|
| Stability within device | A | B | B | B | B | B | B |

TABLE 6

| | | Ex 8 | Ex 9 | Ex 10 | Ex 11 | Ex 12 | Ex 13 |
|---|---|---|---|---|---|---|---|
| Cleaning liquid | | CL 4 | CL 4 | CL 5 | CL 6 | CL 10 | CL 11 |
| Cleaning | Monovalent- | Li ion | Li ion | K ion | Na ion | Li ion | Na ion |
| liquid | metal-salt- | | | | | | |
| | cation | | | | | | |
| | Monovalent- | NO₃ | NO₃ | NO₃ | NO₃ | CH₃COO | CH₃COO |
| | metal-salt- | ion | ion | ion | ion | ion | ion |
| | anion | | | | | | |
| | Water- | 11.2 | 11.2 | 11.2 | 11.2 | 16.7 | 16.7 |
| | soluble- | | | | | | |
| | organic- | | | | | | |
| | solvent | | | | | | |
| | SP value | | | | | | |
| Ink | | Ink 1 | Ink 1 | Ink 1 | Ink 1 | Ink 1 | Ink 1 |
| Pretreatment liquid | | PTL 3 | PTL 1 | PTL 1 | PTL 2 | PTL 1 | PTL 2 |
| Pre- | Polyvalent- | Ca ion | Ca ion | Ca ion | Mg ion | Ca ion | Mg ion |
| treatment- | metal-salt- | | | | | | |
| liquid | cation | | | | | | |
| | Monovalent- | Li ion | — | — | — | — | — |
| | metal-salt- | | | | | | |
| | cation | | | | | | |
| | Monovalent- | NO₃ | — | — | — | — | — |
| | metal-salt- | ion | | | | | |
| | anion | | | | | | |
| Mixing | Ink | B | B | B | B | A | A |
| stability | Pretreatment- | A | A | A | B | B | B |
| | liquid | | | | | | |

| | | | | | | |
|---|---|---|---|---|---|---|
| Stability within device | A | B | B | B | B | B |

TABLE 7

| | | C Ex 1 | C Ex 2 | C Ex 3 | C Ex 4 | C Ex 5 | C Ex 6 |
|---|---|---|---|---|---|---|---|
| Cleaning liquid | | CL 3 | CL 7 | CL 8 | CL 7 | CL 9 | CL 12 |
| Cleaning | Monovalent- | Na ion | Li ion | K ion | Li ion | Na ion | (Ca ion) |
| liquid | metal-salt- | | | | | | |
| | cation | | | | | | |
| | Monovalent- | NO₃ | NO₃ | NO₃ | NO₃ | NO₃ | (CH₃COO |
| | metal-salt- | ion | ion | ion | ion | ion | ion) |
| | anion | | | | | | |
| | Water- | 16.7 | 9.8 | 9.8 | 9.8 | 9.8 | 16.7 |
| | soluble- | | | | | | |
| | organic- | | | | | | |
| | solvent | | | | | | |
| | SP value | | | | | | |
| Ink | | Ink 1 | Ink 1 | Ink 1 | Ink 1 | Ink 1 | Ink 1 |
| Pretreatment liquid | | PTL 1 | PTL 3 | PTL 1 | PTL 6 | PTL 6 | PTL 2 |
| Pre- | Polyvalent- | Ca ion | Ca ion | Ca ion | Ca ion | Ca ion | Mg ion |
| treatment- | metal-salt- | | | | | | |
| liquid | cation | | | | | | |
| | Monovalent- | — | Li ion | — | Na ion | Na ion | — |
| | metal-salt- | | | | | | |
| | cation | | | | | | |
| | Monovalent- | — | NO₃ | — | CH₃COO | CH₃COO | — |
| | metal-salt- | | ion | | ion | ion | |
| | anion | | | | | | |
| Mixing | Ink | A | C | C | C | C | C |
| stability | Pretreatment- | C | B | B | B | C | C |
| | liquid | | | | | | |

| | | | | | | |
|---|---|---|---|---|---|---|
| Stability within device | B | A | B | C | C | B |

As shown in Tables 5 to 7, in Examples 1 to 13, good results were obtained for both the mixing stability between the ink and the cleaning liquid and the mixing stability between the pretreatment liquid and the cleaning liquid. This indicates that excellent cleaning properties can be obtained for both the pretreatment liquid and the ink.

Meanwhile, in Comparative Example 1, in which the metal (cation) of the monovalent metal salt of the cleaning liquid had a lower ionization tendency than the metal (cation) of the polyvalent metal salt of the pretreatment liquid, the mixing stability between the cleaning liquid and the pretreatment liquid was inferior.

Further, in Comparative Examples 2 to 4, in which the SP value of the water-soluble organic solvent contained in the pretreatment liquid was less than 11 (cal/cm^{3)1/2}, the mixing stability between the cleaning liquid and ink was inferior.

In Comparative Example 5, in which the SP value of the water-soluble organic solvent contained in the pretreatment liquid was less than 11 (cal/cm^{3)1/2} and the metal of the monovalent metal salt of the cleaning liquid had a lower ionization tendency than the metal of the polyvalent metal salt of the pretreatment liquid, both of the mixing stability between the ink and the cleaning liquid and the mixing stability between the pretreatment liquid and the cleaning liquid were inferior.

In Comparative Example 6, in which the cleaning liquid contained the salt of the metal having a lower ionization tendency than the metal of the polyvalent metal salt of the pretreatment liquid, but the metal in the cleaning liquid was not a monovalent metal but a polyvalent metal, both of the mixing stability between the ink and the cleaning liquid and the mixing stability between the pretreatment liquid and the cleaning liquid were inferior.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An ink set comprising:
an inkjet aqueous pretreatment liquid containing water and a polyvalent metal salt A;
an aqueous inkjet ink; and
a cleaning liquid containing water, a water-soluble organic solvent B with an SP value of at least 11 (cal/cm^{3)1/2}, and a monovalent metal salt C, wherein
the monovalent metal salt C contains a metal with a higher ionization tendency than a metal of the polyvalent metal salt A.

2. The ink set according to claim 1, wherein
the monovalent metal salt C contains lithium or potassium.

3. The ink set according to claim 1, wherein
the monovalent metal salt C is a nitrate.

4. The ink set according to claim 1, wherein
the inkjet aqueous pretreatment liquid further contains a monovalent metal salt D.

5. The ink set according to claim 4, wherein
the monovalent metal salt D contains a metal which is the same as the metal of the monovalent metal salt C.

6. The ink set according to claim 4, wherein
the monovalent metal salt D contains lithium or potassium.

7. The ink set according to claim 4, wherein
the monovalent metal salt D is a nitrate.
